(19) United States
(12) Patent Application Publication
(10) Pub. No.: US 2013/0334395 A1
(43) Pub. Date: Dec. 19, 2013

(54) MULTI-THICKNESS HARD DISK DRIVE SNUBBER

(71) Applicant: Chih-Wei Tsao, Taiwan (CN)

(72) Inventor: Chih-Wei Tsao, Taiwan (CN)

(73) Assignee: 3M Innovative Properties Company, St. Paul, MN (US)

(21) Appl. No.: 13/976,132

(22) PCT Filed: Dec. 20, 2011
(86) PCT No.: PCT/US11/65969

§ 371 Date: Aug. 28, 2013

Related U.S. Application Data
(60) Provisional application No. 61/427,367, filed on Dec. 27, 2010.

(51) Int. Cl. G06F 1/18

(52) U.S. Cl. CPC G06F 1/187
USPC 248/638

(57) ABSTRACT

An apparatus is provided for mounting and protecting a subject object, such as, in some embodiments, a hard disk drive, comprising: a) a damping structure comprising an elastomeric material adapted to partially cover the subject object; and b) an insert plate assembly borne in the damping structure comprising: i) an insert plate, and ii) a screw, post, dowel or pin adapted to engage a mounting hole in the subject object.

### CROSS REFERENCE TO RELATED APPLICATION

This application claims the benefit of U.S. Provisional Patent Application No. 61/427,367, filed Dec. 27, 2010, the disclosure of which is incorporated by reference herein in its entirety.

### FIELD OF THE DISCLOSURE

This disclosure relates to a mount for a hard disk drive (HDD) or other sensitive or fragile object which additionally functions as a snubber, i.e., a device which suppresses or snubs excess force or rapid movement.

### SUMMARY OF THE DISCLOSURE

Briefly, the present disclosure provides an apparatus for mounting and protecting a subject object, such as, in some embodiments, a hard disk drive, comprising: a) a damping structure comprising an elastomeric material adapted to partially cover the subject object; and b) an insert plate assembly borne in the damping structure comprising: i) an insert plate, and ii) a screw, post, dowel or pin adapted to engage a mounting hole in the subject object. In some embodiments, the insert plate has two major faces including an inner major face which faces the subject object and an outer major face which faces away from the subject object, and the outer major face is substantially covered by the elastomeric material of the damping structure. In some embodiments, both major faces are substantially covered by the elastomeric material of the damping structure. In some embodiments, the apparatus comprises at least two insert plate assemblies mounted so as to engage opposite sides of the subject object. In some embodiments, the damping structure is adapted so as to contacts at least four sides of the subject object; in some embodiments at least five sides of the subject object; and in some embodiments at least six sides of the subject object. In some embodiments, the insert plate is a piece separate from the screw, post, dowel or pin. In some embodiments, the insert plate and the screw, post, dowel or pin are unitary. In some embodiments, the insert plate and the screw, post, dowel or pin are integral. In some embodiments, the insert plate and the screw, post, dowel or pin are integrally formed.

### BRIEF DESCRIPTION OF THE DRAWING

FIG. 1A is a view of an embodiment of the apparatus of present disclosure with mounted hard disk drive.

FIG. 1B is a cross section of the embodiment of the present disclosure depicted in FIG. 1A.

FIG. 2A is a view of an embodiment of the apparatus of the present disclosure.

FIG. 2B is a view of a component of an embodiment of the apparatus of the present disclosure.

FIG. 2C is a detail of an embodiment of the apparatus of the present disclosure.

FIG. 3A is a view of an embodiment of the apparatus of the present disclosure.

FIG. 3B is a view of a component of an embodiment of the apparatus of the present disclosure.

FIG. 3C is a detail of FIG. 3A.

### DETAILED DESCRIPTION

The present disclosure provides an apparatus for mounting and protecting a subject object. In some embodiments, the present disclosure provides an apparatus for supporting a hard disk drive (HDD) in a device while providing protection from shock and vibration events. In some embodiments, the apparatus is capable of supporting two or more sizes of HDD. In some embodiments, the apparatus is capable of supporting two or more sizes of 2.5″ HDD selected from 12.7 mm thickness, 12.5 mm thickness, 9.5 mm thickness and 7.0 mm thickness. In some embodiments, the device is a portable device. In some embodiments, the apparatus is a universal mount/isolator/snubber.

In many embodiments the subject object to be protected by the apparatus according to this disclosure is an HDD. In some embodiments the subject object is any object with mounting holes that can be engaged by the screw, post, dowel or pin of an insert plate assembly, as described below.

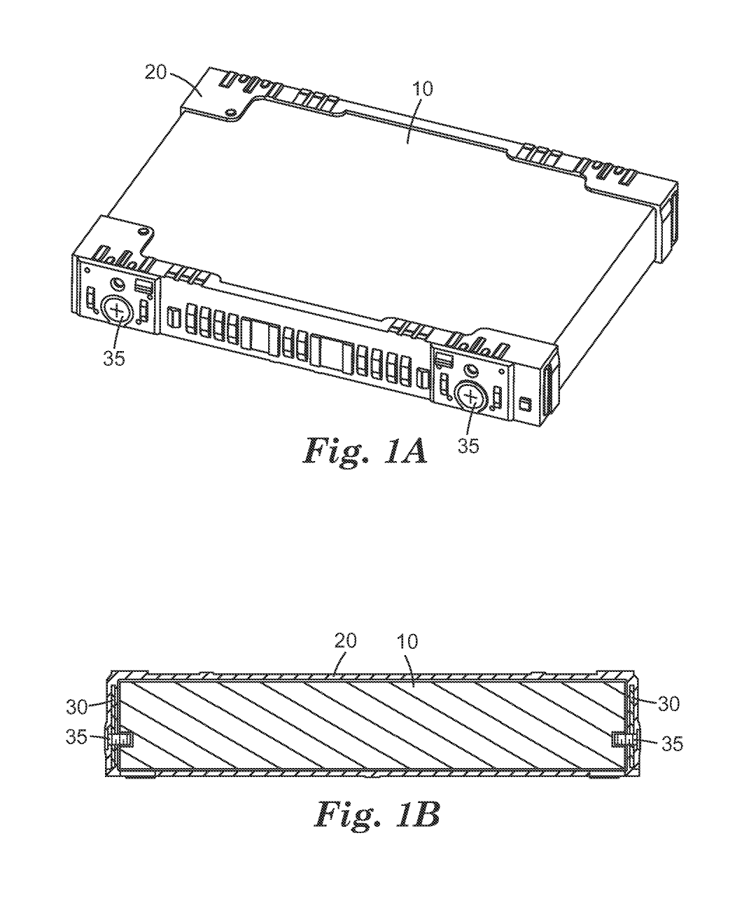

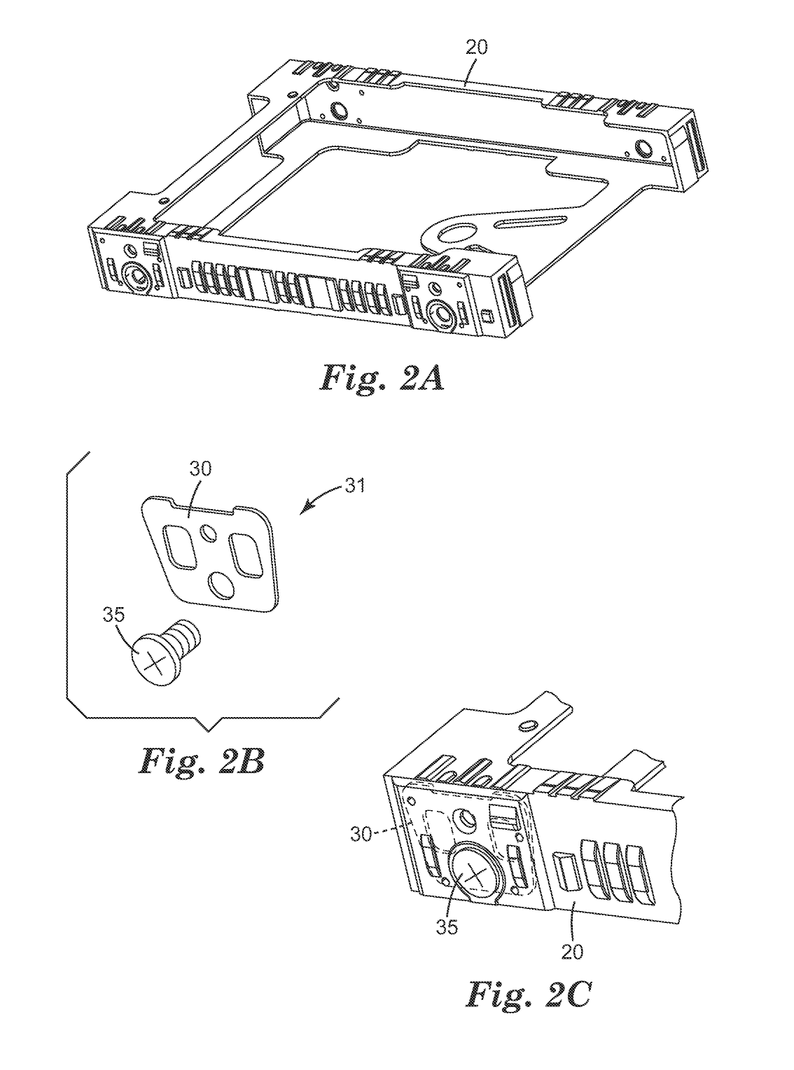

With reference to FIGS. 1A, 1B, 1C, 2A, 2B and 2C, in some embodiments the apparatus includes an insert plate 30. The insert plate 30 may be made of any suitable material. In some embodiments, suitable materials may include metal or plastic. In some embodiments, suitable materials may include stainless steel, SECC, ABS, PC/ABS or PC. The insert plate may be made by any suitable method, which may include stamping, injection molding and compression molding.

The insert plate is borne in a damping structure 20 made of elastomeric material. The damping in the elastomeric material provides energy dissipation from a shock or vibration input, reducing the effects of high level acceleration that could be destructive to the HDD. The elastomeric material may be any suitable highly damped and moldable elastomer. Suitable elastomers may include PU, PET and Silicone. The damping structure may be made by any suitable method, which may include injection molding and compression molding. Damping structure 20 may contain one, two, three, four, five, six, or more of insert plate 30. In some embodiments, one, two, three, four, five, six, or more of insert plate 30 are located in the walls of damping structure 20 during the process of molding damping structure 20. In some embodiments the damping structure partially covers the HDD or other subject object to be mounted and protected by the assembly of the present disclosure. In some embodiments, the damping structure contacts at least two of the six sides of the HDD, which is substantially a rectangular prism. n some embodiments, the damping structure contacts at least three sides of the HDD. In some embodiments, the damping structure contacts at least four sides of the HDD. In some embodiments, the damping structure contacts at least five sides of the HDD. In some embodiments, the damping structure contacts six sides of the HDD.

In this embodiment, the insert plate 30 bears or includes at least one screw 35 capable of engaging a mounting hole in an HDD. Insert plate 30 and associated screw 35 together make up insert plate assembly 31. The screw may be made of any suitable material. In some embodiments, suitable materials may include metal or plastic. In some embodiments, suitable materials may include stainless steel, SECC, ABS, PC/ABS or PC.

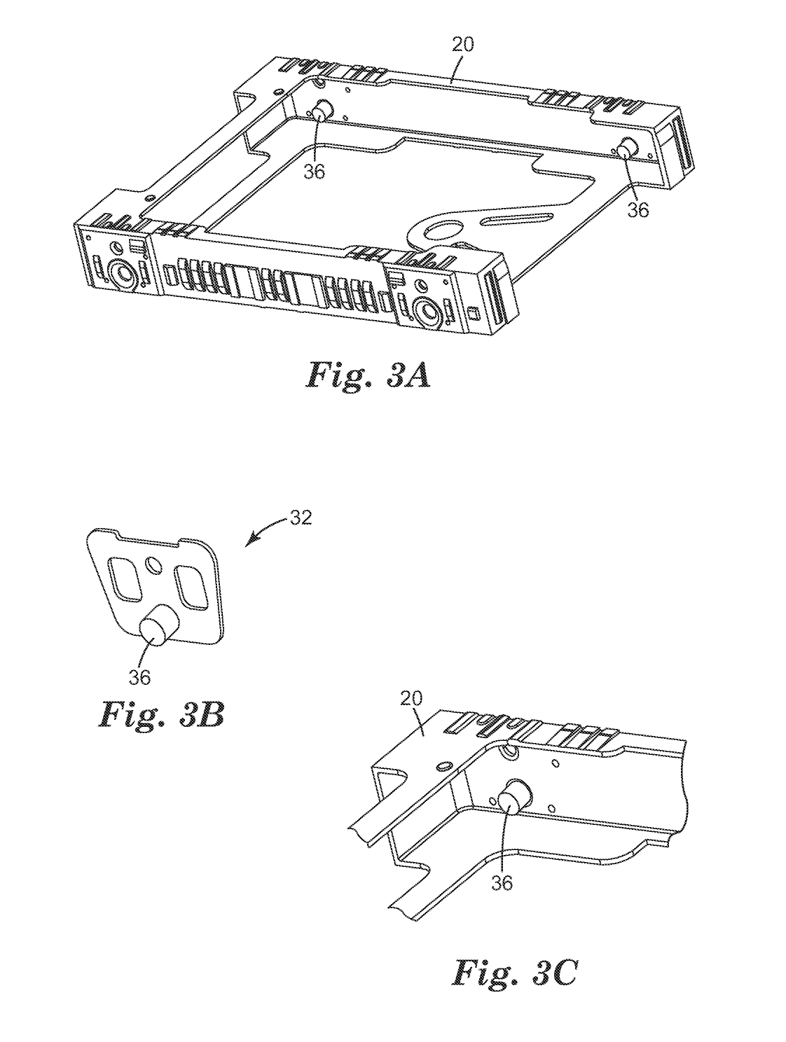

With reference to FIGS. 3A, 3B and 3C, in some embodiments the apparatus includes an insert plate assembly 32 which includes an insert plate portion and a pin 36 capable of engaging a mounting hole in an HDD. In some embodiments pin 36 is an integral part of insert plate assembly 32. In some embodiments pin 36 is a unitary part of insert plate assembly 32.

In general, the insert plate assembly includes an insert plate and at least one screw, post, dowel or pin capable of engaging a mounting hole in an HDD. In some embodiments, the insert plate is a piece separate from the screw, post, dowel or pin. In some embodiments, the insert plate and its associated screw, post, dowel or pin are unitary. In some embodiments, the insert plate and its associated screw, post, dowel or pin are integral. In some embodiments, the insert plate and its associated screw, post, dowel or pin are integrally formed. The screw, post, dowel or pin may be made of any suitable material. In some embodiments, suitable materials may include metal or plastic. In some embodiments, suitable materials may include stainless steel, SECC, ABS, PC/ABS or PC.

With reference to FIGS. 1A, 1B, 2A and 2C, in some embodiments the insert plate 30 is substantially covered by the elastomeric material of damping structure 20. In some embodiments the insert plate 30 comprises two major faces and each major face is substantially covered by the elastomer material of damping structure 20. In some embodiments the insert plate 30 comprises two major faces, including an inner major face which faces the HDD (or other subject object) and an outer major face which faces away from the HDD (or other subject object), and the outer major face is substantially covered by the elastomeric material of damping structure 20. With reference to FIGS. 3A and 3C, in some embodiments the insert plate assembly 32 is substantially covered by the elastomeric material of damping structure 20. In some embodiments the insert plate assembly 32 comprises an insert plate portion 33 having two major faces and each major face is substantially covered by the elastomeric material of damping structure 20. In some embodiments the insert plate assembly 32 comprises an insert plate portion having two major faces, including an inner major face which faces the HDD (or other subject object) and an outer major face which faces away from the HDD (or other subject object), and the outer major face is substantially covered by the elastomeric material of damping structure 20.

With reference to FIGS. 1A, 1B, 2A and 3A, in some embodiments damping structure 20 includes at least two insert plates 30 or insert plate assemblies arranged on opposing sides of damping structure 20 from each other, so as to engage with opposing sides of the HDD. In some embodiments damping structure 20 includes at least four insert plates 30 or insert plate assemblies arranged with two on each of two opposing sides of damping structure 20, so as to engage with opposing sides of the HDD. The screw, post, dowel or pin is mounted to the inside of embodiments damping structure 20 so as to be capable of engaging a mounting hole in an HDD.

Various modifications and alterations of this disclosure will become apparent to those skilled in the art without departing from the scope and principles of this disclosure, and it should be understood that this disclosure is not to be unduly limited to the illustrative embodiments set forth hereinabove.

1. An apparatus for mounting and protecting a subject object comprising:
a) a damping structure comprising an elastomeric material adapted to partially cover the subject object;
b) an insert plate assembly borne in the damping structure comprising:
i) an insert plate, and
ii) a screw, post, dowel or pin adapted to engage a mounting hole in the subject object.

2. The apparatus according to claim 1 wherein the insert plate has two major faces and each major face is substantially covered by the elastomeric material of the damping structure.

3. The apparatus according to claim 1 wherein the insert plate has two major faces including an inner major face which faces the subject object and an outer major face which faces away from the subject object, and the outer major face is substantially covered by the elastomeric material of the damping structure.

4. The apparatus according to claim 1 comprising at least two insert plate assemblies mounted so as to engage opposite sides of the subject object.

5. The apparatus according to claim 2 comprising at least two insert plate assemblies mounted so as to engage opposite sides of the subject object.

6. The apparatus according to claim 1 wherein the damping structure is adapted so as to contacts at least four sides of the subject object.

7. The apparatus according to claim 1 wherein the damping structure is adapted so as to contacts at least five sides of the subject object.

8. The apparatus according to claim 1 wherein the damping structure is adapted so as to contacts at least six sides of the subject object.

9. The apparatus according to claim 2 wherein the damping structure is adapted so as to contacts at least six sides of the subject object.

10. The apparatus according to claim 4 wherein the damping structure is adapted so as to contacts at least six sides of the subject object.

11. The apparatus according to claim 5 wherein the damping structure is adapted so as to contacts at least six sides of the subject object.

12. The apparatus according to claim 1 wherein the insert plate assembly comprises:
i) an insert plate, and
ii) a screw.

13. The apparatus according to claim 1 wherein the insert plate assembly comprises:
i) an insert plate, and
ii) a post, dowel or pin.

14. The apparatus according to claim 1 wherein the insert plate is a piece separate from the screw, post, dowel or pin.

15. The apparatus according to claim 1 wherein the insert plate and the screw, post, dowel or pin are unitary.

16. The apparatus according to claim 1 wherein the insert plate and the screw, post, dowel or pin are integral.

17. The apparatus according to claim 1 wherein the insert plate and the screw, post, dowel or pin are integrally formed.
